(19) United States
(12) Patent Application Publication
(10) Pub. No.: US 2002/0142693 A1
(43) Pub. Date: Oct. 3, 2002

(54) Absorbent device for insertion into a vaginal cavity

(76) Inventor: Herve Buzot, North Brunswick, NJ (US)

Correspondence Address: AUDLEY A. CIAMPORCERO JR., JOHNSON & JOHNSON, ONE JOHNSON & JOHNSON PLAZA, NEW BRUNSWICK, NJ, 08933-7003, US

(21) Appl. No.: 09/823,045

(22) Filed: Mar. 30, 2001

(51) Int. Cl. D04H 1/00; D04H 3/00; D04H 5/00; D04H 13/00; B32B 21/10

(52) U.S. Cl. 442/414; 442/327; 442/413

(57) ABSTRACT

A catamenial absorbent device for insertion into a vaginal cavity having two portions: an overwrap containing an absorbent structure. The overwrap has two portions: a lower, fluid impermeable barrier, an upper, fluid-permeable overwrap, and the absorbent structure contains absorbent material therein. The two portions of the overwrap are made from dissimilar materials, which are joined at a junction.

### FIELD OF THE INVENTION

The invention relates to novel absorbent devices for insertion into a vaginal cavity, such as catamenial tampons and medical devices. More particularly, the present invention relates to a tampon having an overwrap. The overwrap has an upper liquid impermeable portion, a lower liquid impermeable portion and contains absorbent material therein.

### BACKGROUND OF THE INVENTION

Commercial catamenial tampons are often comprised of an absorbent body of moderately compressed fibers, and these tampons are generally in the shape of a cylinder or a bullet. These tampons are generally described in Friese et al., EP 422 660, Friese, U.S. Pat. No. 4,816,100, and Nguyen et al., U.S. Pat. No. 5,750,446. Examples of such tampons are the commercially available o.b.® tampons.

Olevsky, U.S. Pat. No. 4,374,522, discloses a bullet-shaped pledget in which the inner portion is hollow and the bottom portion has a liquid impermeable layer.

A second type is a tampon that is more prevalent in the patent art than it is commercially available has multiple pieces of absorbent material encased within a porous overwrap. This is commonly known as a bag-type tampon. The bag-type tampon provides certain advantages over the first tampon type. They may have greater absorbent capacity than commercial tampons, may have more bulk for containment of fluids, and the particulate absorbent provides a large amount of surface area.

Examples of bag-type tampons are shown in Schaefer, U.S. Pat. No. 3,815,601, Reeves et al, U.S. Pat. No. 4,278,088, and Davis et al. U.S. Pat. No. 3,791,385.

What is needed is a catamenial absorbent device having an absorbent structure that is capable of absorbing adequate amounts of bodily fluids contained within a fluid permeable overwrap while having a fluid impervious portion to prevent leakage of the bodily fluid.

### SUMMARY OF THE INVENTION

A catamenial absorbent device having two portions: an overwrap containing an absorbent structure. The overwrap has two portions: a lower, fluid impermeable barrier, an upper, fluid-permeable overwrap, and the absorbent structure contains absorbent material therein. The two portions of the overwrap are made from dissimilar materials, which are joined at a junction.

### BRIEF DESCRIPTION OF THE DRAWINGS

FIG. 1 is an elevational view of the catamenial device according to the present invention; and

FIG. 2 is a cross-section of the catamenial device as viewed upon placement within the vaginal cavity.

### DETAILED DESCRIPTION OF THE INVENTION

In general, this invention relates to an absorbent device having two portions: an overwrap containing an absorbent structure. The overwrap has two portions: a lower, fluid impermeable barrier, an upper, fluid-permeable overwrap, and the absorbent structure contains absorbent material therein. The two dissimilar materials of the overwrap may be joined at a junction. By having the upper portion of the absorbent device made from a liquid permeable, nonwoven material, fluid can penetrate into the inner portion of the device where it is absorbed by the absorbent material. The lower portion of the absorbent device can prevent leakage of the bodily fluid from the absorbent means.

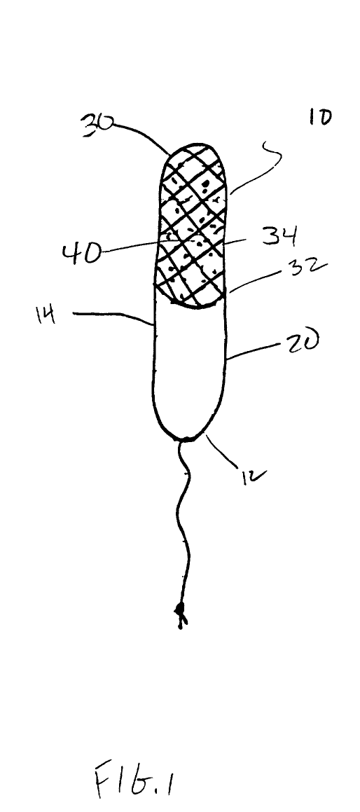

FIG. 1 shows absorbent device 10 in non-expanded form and having lower portion 20, upper portion 30 and absorbent material 40.

Lower portion 20 is formed on the bottom surface 12 of absorbent article 10 and may extend up sides 14 of absorbent device 10. Preferably, lower portion 20 wraps around a portion of the absorbent structure 40 and is attached to upper portion 30 at junction 32.

Lower portion 20 is an impermeable barrier that prevents fluid from passing from the vaginal canal. Additionally, lower portion 20 is flexible and resilient enough to form a seal with the vaginal cavity when absorbent device 10 is filled with fluid. Lower portion 20 may form a reservoir to collect fluid when absorbent material 40 is fully saturated.

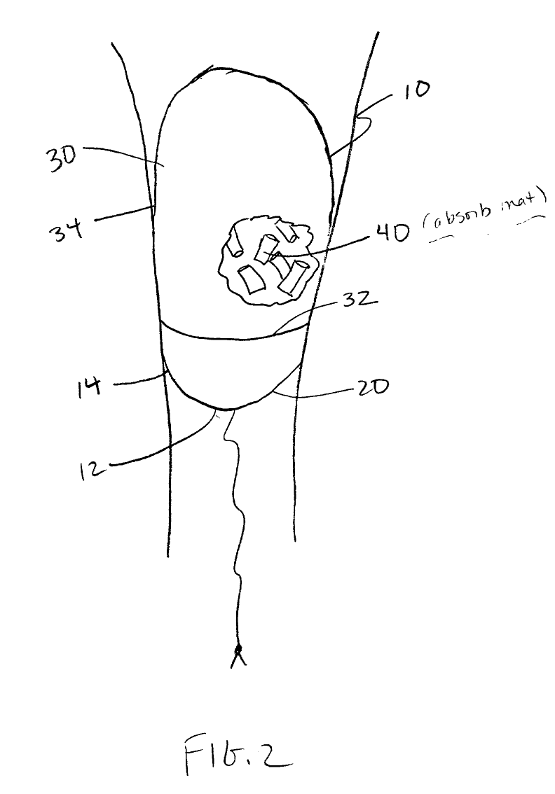

As shown in FIGS. 1 and 2, upper portion 30 may be sack-like and wraps around that portion of absorbent structure 40 not wrapped by lower portion 20. The absorbent structure is preferably formed from an expandable or non-expandable material. The absorbent structure can also be an aggregate of materials. If the absorbent material is expandable, it preferably has a sufficiently high resiliency to allow the upper portion 30 and lower portion 20 to open, expand and contact the walls of the body cavity upon placement into the body cavity. In a preferred embodiment, the absorbent material is expandable. Upper portion 30 is permeable and has a structure similar to a net allowing fluid to pass through. Lower portion 20 is non-permeable and does not allow the fluid to pass. Thus, the bottom part of the sack is capable of forming a barrier and also of collecting the fluid thereby preventing leakage of bodily fluids during wear.

FIG. 2 shows cross-section of expanded absorbent device 10 within the vaginal canal. The lower portion 20 collects the fluid at times when the absorbent structure 40 is unable, for example, during gushes or upon saturation of the absorbent structure. Optimally, when the absorbent device 10 is fully expanded, it fits against the vaginal walls to prevent fluid leakage past the absorbent device to stain the user's clothes.

When absorbent device 10 is used as a tampon, fluid penetrates through upper portion 30 and is absorbed by absorbent structure 40. Absorbent structure 40 expands as the fluid is absorbed and upper portion 30 contacts the vaginal walls. Bodily fluid is therefore prevented from bypassing absorbent device 10.

Once the absorbent structure 40 has fully expanded, the fit of the absorbent device 10 is optimum.

As previously mentioned, lower portion 20 is an impermeable barrier that can also collect fluid. It is preferred that lower portion 20 is thin and resilient. In a preferred embodiment, lower portion 20 is a thin, flexible film or a coated fabric. Examples of materials for lower portion 20 include any type of pliable film-forming or coating material including polymeric materials such as polyethylene, polypropylene, polystyrene, polyvinyl alcohol, polylactic acid, poly(3-hydroxybutyric acid), rubber and other elastomers, and combinations thereof. In particular, thermoplastic materials such as polypropylene and polyethylene, rubber, and elastomers are preferred.

Lower portion 20 may be made integral, of the same resiliency and substantially same wall thickness throughout. Since lower portion 20 including sidewalls 14 forms a cup-like structure, it will yield more readily than were it flat as the latter would have to be buckled or compressed to allow partial folding of the adjacent sidewalls. Lower portion 20 may also be substantially conical, cylindrical, parabolic or acorn shaped, i.e., a form which is susceptible of being folded easily. This is especially useful if absorbent device 10 is placed within an applicator similar to those used with tampons.

The material chosen for lower portion 20 must have sufficient softness and yieldability as to not exert any undue pressure on the vaginal walls. The material must be pliable and moisture impervious. An example of such material is a good grade of soft rubber.

The thickness of the walls may influence the choice of materials used to form lower portion 20. For example, the thinning of sidewall 14 towards junction 32 facilitates the folding of the upper portion 30 for insertion purposes or placement into an applicator. Additionally, a thicker walled bottom surface 12 adds to longitudinal stability during insertion.

Lower portion 20 forms a receptacle from soft, impervious, imperforate, resilient material, which in a digital application, may be folded by pressure of the human fingers and inserted in the vagina in the distorted or folded condition. Alternately, absorbent device 10 may be placed into an applicator and placed into a body cavity.

Additionally, the lower portion of the absorbent article may provide means to remove the absorbent device after use, e.g., an extension of the absorbent device itself or an attached element such as a removal string. An example of an extension may include a tab having an opening for securing a removal string. Examples of materials suitable for use as removal string include cotton string and any string sufficiently strong enough to withstand removal forces used to removal the absorbent device from the body cavity. Polyester strings may also be used.

Optionally, a strengthening ring may be included on upper end or at junction 32 of lower portion 20. The strengthening ring may provide resilience, tending to expand the upper end of the cup-like structure to its open position or to maintain it in that position.

Upper portion 30 is formed from liquid permeable material that is capable of containing the absorbent material 40 and any other associated material within the bag. Suitable materials for upper portion 30 include those with open mesh structures such as woven, nonwoven, and knit textiles; aperture films; polymeric nets; and the like. Preferably, the fluid-permeable materials are soft, flexible, and have small apertures therethrough. Additional desirable features can include biodegradability.

Useful overwrap materials enable easy sack formation and sealing to lower portion 20. Therefore, qualities such as thermobondability, high tensile strength, high masking effect to prevent users from noticing absorbent material such as pledgets, tablets or pellets. Additionally, softness is desirable. It is desirable to have upper portion 30 and lower portion 20 attached or adhered to one another to form a cohesive unit to enhance the article's stability. Such attachment or adherence may be by any known means, including, for example, adhesive, ultrasonics, co-embossing, thermobonding, mechanical bonding, and the like.

It is not necessary for the liquid permeable material or overwrap material to have noticeable apertures therein, but some materials having noticeable apertures have been used satisfactorily. The apertures must, however be small enough to keep small pieces and/or fibers from escaping through the overwrap and to prevent edges or corners of the absorbent material from protruding through the overwrap. Additionally, protrusion of the absorbent material through apertures may interfere with ejection of absorbent article or tampon from applicator. Thus, the outer surface of the overwrap should be as smooth and have as low a coefficient of friction as possible. This provides at least two benefits: (1) the force required to eject the tampon is reduced from an applicator, if used, and (2) it reduces the damage otherwise caused by scraping of soft, tender tissue within the vagina during insertion, wearing and removal.

The upper portion material and overwrap should be strong enough to prevent rupturing during handling, insertion, removal and from vaginal pressures during use.

Especially preferred materials include cotton, rayon, cotton:rayon blends, polyester, hydrophobic, and spunbonded nonwoven materials. The use of any highly hydrophobic materials can be advantageous in that it insulates the vaginal wall from collected menses and thus maintains, during menstruation, the slightly acidic condition of the vagina which exists during non-menstrual times.

Sidewall 34 of upper portion 30 may contact the vaginal walls and adapt to the ridges and folds in the vaginal wall. This helps prevent leakage.

The absorbent structure may be formed of any material that absorbs fluid either into itself or into pores and/or capillaries within the structure and is preferably a fibrous material. The absorbent structure may be in the shape of a pledget, tablets, formed cylinders, sheets, ovoids, spheres or any other shape that is preferred. The absorbent material may be a blend of fibers or an aggregate of fibers. The absorbent material may also be a combination or blend of shapes and loose fibers.

Although not necessary, the absorbent material may be compressible, that is, the material may be compressed to hold a generally compressed form (such as when in an applicator), but the material can expand to a relatively uncompressed state upon exposure to sufficient moisture.

If a blend of fibers is used as the absorbent material, the fibers are preferably blended to a substantially uniform mixture of fibers. Those of ordinary skill in the art know useful fiber blending operations. For example, the fibers can be continuously metered into a saw-tooth opener. The blended fibers can be transported, e.g., by air through a conduit to a carding station to form a fibrous web. The fibrous web is preferably calendered to impart a minor amount of compression.

Pledgets are usually substantially cylindrical masses of compressed absorbent material having a central axis and a radius that defines the outer circumferential surface of the tampon. Pledgets are often formed by first obtaining a shaped mass of absorbent material called a blank. This blank can be in the form of a roll of sheet-like material, a segment of a continuous absorbent material, a mass of randomly or substantially uniformly oriented absorbent material, an individually prepared or cast mass of absorbent material, and the like.

The blank is relatively uncompressed and has a relatively low density. It is then compressed to form a product having overall dimensions less than those of the blank prior to use. The compressed pledgets may have a generally uniform density throughout the pledget, or they may have regions of differing density as described in the commonly assigned applications to Friese et al., U.S. Ser. No. 07/596,454, and Leutwyler et al., U.S. Pat. No. 5,813,102, the disclosures of which are herein incorporated by reference.

The fibrous, absorbent material includes bondable fibers, bondable fiber blends, and/or fibers combined with binding agents. This allows the absorbent material to remain compressed. Preferably, at least a portion of the fibers is capable of hydrogen bonding. Hydrogen bonding holds the fibers in a compressed form until to moisture breaks the bonds. Other bondable fibers may have a bondable surface treatment that is releasable in a moist (water vapor) or aqueous liquid environment. Binding agents may also be used to maintain the compression of the tablets, including without limitation, water-soluble binding agents, waxes, glues and the like.

Preferably, the fibers include hydrophilic fibers, and more preferably, the fibers include absorbent fibers, i.e., the individual fibers, themselves, absorb fluid. A useful, non-limiting list of useful tampon fibers includes natural fibers such as cotton, wood pulp, jute, and the like; and processed fibers such as regenerated cellulose, cellulose nitrate, cellulose acetate, rayon, polyester, polyvinyl alcohol, polyolefin, polyamine, polyamide, polyacrylonitrile, and the like. Other fibers in addition to the above fibers may be included to add desirable characteristics to the absorbent body. For example, hydrophobic fibers may be used in outer surfaces of the tampon to reduce surface wetness and hydrophilic fibers may be used to increase the rate of fluid transport into and throughout the body. Preferably, the tampon fibers are rayon or cotton, and more preferably, the fibers are rayon. The fibers may have any useful cross-section.

A representative, non-limiting list of cellulosic fibers includes natural fibers such as cotton, wood pulp, jute, bagasse, silk, wool, and the like; and processed fibers such as regenerated cellulose, cellulose acetate, cellulose nitrate, rayon, and the like. Preferably, the cellulosic fibers are rayon or cotton, and more preferably, the fibers are rayon.

The fibers can also be multi-limbed, including multi-limbed regenerated cellulosic fibers and multi-limbed polyester or polyolefin fibers. A preferred source of multi-limbed regenerated cellulosic fibers are available as DANUFIL VY viscose rayon fibers from Acordis Ltd., Birmingham, England. These fibers are described in detail in Wilkes et al., U.S. Pat. No. 5,458,835, the disclosure of which is hereby incorporated by reference. It is expected that any multi-limbed commercial fiber or even other such fibers not currently commercially available, would be useful in the practice of this invention.

Again, additional fibers may be added. These additional fibers may include synthetic fibers such as polyesters, polyvinyl alcohols, polyolefins, polyamines, polyamides, polyacrylonitriles, and the like.

Different fibers can withstand varying levels of compression before exhibiting significant levels structural damage. We have found that the multi-limbed rayon fibers, for example, encounter less damage upon high compression than other fibers such as cotton or polyester (PET) fibers. This type of fiber can better use the region of the maximum volume capacity and thus can be used to optimize tampon characteristics.

If tablets are used as the absorbent material, the tablets may be formed of 100% of a single fiber type, or they may be formed of a blend of two or more different fibers. For example, blends of multi-limbed and non-limbed rayon may be used. Additionally, blends of rayon and one or more of the fibers listed above can be used.

Additionally, materials having resiliency may be used to absorb bodily fluids. For example, foams, sponges, hydrogels, or an aggregate of separate pieces of low modulus, resilient, absorbent foam may be used. The aggregate may also include an ancillary absorbent material such as fiber to hold liquids within the absorbent body.

In a preferred embodiment, the absorbent material is compressed into tablet-like pieces having a density greater than the uncompressed state as described in commonly assigned, co-pending U.S. Ser. No. 09/741,718, filed Dec. 20, 2000. In another embodiment, the absorbent material is compressed into a matt and squares are cut from the matt.

When constructed and placed within the vaginal cavity, there is no relative movement between the vaginal walls and the tampon. The tampon conforms to the vaginal cavity and any contours thereof. The tampon has a smooth surface such that no abrasion occurs when the tampon is inserted or removed.

The present invention can absorb and collect fluid. The present invention discloses an absorbent catamenial device having a flexible upper portion containing absorbent material capable of collecting fluid and a flexible lower portion having a barrier to prevent leakage. The absorbent material may or may not expand.

We claim:

1. An absorbent device for insertion into a vaginal cavity, said absorbent device comprising an overwrap and an absorbent structure, the overwrap comprising an upper portion and a lower portion, said overwrap comprised of dissimilar materials such that said upper portion comprising a liquid permeable material and said lower portion comprising a liquid impermeable material, said upper and lower portions joined to form a container for said absorbent material, said lower portion contacting walls of said vaginal cavity and said absorbent structure comprising absorbent material.

2. An absorbent device of claim 1, wherein said absorbent material comprises a fibrous material.

3. An absorbent device of claim 2, wherein said fibrous, absorbent material comprises a binding agent.

4. An absorbent device of claim 3, wherein said binding agent is water soluble.

5. An absorbent device of claim 1, wherein said absorbent material is bondable fiber.

6. An absorbent device of claim 5, wherein said bondable fiber comprises cellulosic fibers.

7. An absorbent device of claim 6, wherein said cellulosic fibers comprise multi-limbed regenerated cellulosic fibers.

8. An absorbent device of claim 6, wherein said cellulosic fibers comprise non-limbed cellulosic fibers.

9. An absorbent device of claim 6, wherein said cellulosic fibers comprise a mixture of multi-limbed regenerated cellulosic fiber and non-limbed regenerated cellulosic fiber.

10. An absorbent device of claim 2, wherein said fiber is compressed.

11. An absorbent means of claim 1, wherein said absorbent material comprises a pledget.

12. An absorbent means of claim 1, wherein said absorbent material comprises a plurality of compressed tablets.

13. An absorbent device of claim 1, wherein said absorbent material comprises foam.

14. An absorbent device of claim 1, wherein said upper portion comprises a non-woven material.

15. An absorbent device of claim 1, wherein said upper portion comprises an apertured film.

16. An absorbent device of claim 1, wherein said lower portion comprises a film.

17. An absorbent device of claim 16, wherein said film is selected from the group consisting of polyethylene, polypropylene, rubber, elastomers and combinations thereof.

18. An absorbent device of claim 16, wherein said lower portion comprises a bottom portion and a sidewall.

19. An absorbent device of claim 18, wherein said bottom portion is thicker than said sidewall.

20. An absorbent device of claim 18, wherein said bottom portion has extending therefrom a body withdrawal mechanism.

21. An absorbent device of claim 1, further comprising a withdrawal string.

22. An absorbent device of claim 21, wherein a withdrawal string is attached to said bottom portion.

23. An absorbent device of claim 1, wherein said upper portion and said lower portion are joined at a junction, said junction formed by thermobonding.

24. An absorbent device of claim 1, further comprising a strengthening ring, said ring capable of maintaining said lower portion into an open position.

25. An absorbent device for insertion into a vaginal cavity, the absorbent device comprising an absorbent structure contained within an overwrap, the overwrap comprising a liquid permeable upper portion and a liquid impermeable lower portion, the absorbent structure comprising aggregate absorbent material.

26. An absorbent device of claim 25, wherein the upper portion comprises a non-woven material.

27. An absorbent device of claim 25, wherein the lower portion comprises a film.

28. An absorbent device of claim 25, wherein the upper portion comprises an apertured film.

29. An absorbent device of claim 25, wherein the absorbent material comprises fibers.
